(19) United States
(12) Patent Application Publication
(10) Pub. No.: US 2007/0086421 A1
(43) Pub. Date: Apr. 19, 2007

(54) Wireless relay apparatus and wireless relay method

(75) Inventors: Jin-woo Hong, Suwon-si (KR); Dae-gyu Bae, Suwon-si (KR); Hyun-ah Sung, Seoul (KR); Se-Hoon Moon, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/524,917

(22) Filed: Sep. 22, 2006

(30) Foreign Application Priority Data
Sep. 23, 2005 (KR) 10-2005-088917

(51) Int. Cl. H04J 3/24

(52) U.S. Cl. 370/349

(57) ABSTRACT

A wireless relay apparatus and method of extending a wireless communication range between a host and a device by relaying packets between the host and the device in a wireless universal serial bus environment. The wireless relay apparatus includes a management packet analyzing unit which receives a management packet including channel time allocation information and information related to the transmission direction of data and analyzes the management packet; a response packet analyzing unit which receives a response packet, which is a response to the management packet, from a wireless USB device and analyzes the response packet; a control unit which controls a stream of data between a wireless USB host and the wireless USB device with reference to the analyzed management packet and the analyzed response packet; and a transmitting/receiving unit which transmits or receives the management packet, the response packet, or data according to the result of the control.

### CROSS-REFERENCE TO RELATED APPLICATION

This application claims the benefit of Korean Patent Application No. 10-2005-088917, filed on Sep. 23, 2005, in the Korean Intellectual Property Office, the disclosure of which is incorporated herein by reference in its entirety.

### BACKGROUND OF THE INVENTION

1. Field of the Invention

Apparatuses and methods consistent with the present invention relate to a wireless relay, and more particularly, to a wireless relay for extending a wireless communication range between a host and a device by relaying packets between the host and the device in a wireless universal serial bus environment.

2. Description of the Related Art

With the development of communication and network techniques, in recent years, wired network environments using a wire medium, such as a coaxial cable or an optical cable, have changed into wireless network environments using radio waves in various frequency bands.

Such wireless networks are classified into two types: wireless networks including an access point 110, as shown in FIG. 1; and wireless networks not including an access point, as shown in FIG. 2. The wireless network including an access point is referred to as an ‘infrastructure-mode wireless network’. In the infrastructure-mode wireless network, the access point 110 functions to relay data in order to connect a wireless network to a wire network or to enable communication among wireless network apparatuses belonging to a wireless network. Therefore, in the infrastructure-mode wireless network environment, all data is transmitted through the access point 110.

Meanwhile, the wireless network not including an access point is referred to as an ‘ad-hoc-mode wireless network’. In the ad-hoc-mode wireless network, data packets are transmitted directly among multiple wireless network devices belonging to a single wireless network, without passing through a relay apparatus, such as the access point.

Ad-hoc-type wireless networks are also divided into two types. In one type of ad-hoc-mode wireless network, one wireless network device is arbitrarily selected from multiple wireless network apparatuses belonging to a single wireless network and serves as an arbitrator for allocating data packet transmission time (hereinafter, referred to as ‘channel time’) to the other wireless network apparatuses, and the other wireless network apparatuses transmit the data packets in the channel time allocated thereto.

In the other type of ad-hoc-mode wireless network, a wireless network apparatus serving as an arbitrator is not provided and each of the wireless network apparatuses are able to transmit data packets freely therebetween by mutual agreement.

Wireless interfaces for connecting network apparatuses are needed to enable communication in a wireless network environment. These wireless interfaces include, for example, IrDA and Bluetooth. In recent years, research has been conducted on a wireless universal serial bus (wireless USB), which is an advanced version of universal serial bus (USB), a conventional wire interface.

The following is a brief description of advantages of a universal serial bus over a serial port. A serial port has a maximum speed of 100 Kbps, but the universal serial bus can support a data transmission speed of 12 Mbps. In addition, when the universal serial bus is used as an interface between network apparatuses, it is possible to reduce the number of adapters and thus to simplify the structure of the network apparatus. Further, the use of the universal serial bus makes it unnecessary to install additional software or hardware when peripheral apparatuses are connected to a PC. In addition, since all peripheral apparatuses are connected to the PC using the same connectors, it is possible to considerably reduce the number of ports. Also, the universal serial bus can be easily installed, and thus it is possible to reduce the size of a portable PC.

The wireless universal serial bus transmits or receives packets in a physical frequency band of an ultra wide band (UWB), and the wireless communication area thereof is limited to about 10 m. That is, in the wireless universal serial bus environment, the host can transmit or receive packets to or from only the devices within a radius of 10 m. In recent years, USBs have come into widespread use due to their use in connecting individual apparatuses, such as a camcorder and a digital camera, to a PC, in addition to connecting peripheral apparatuses, such as a mouse, a printer, and a modem, to the PC. Therefore, it is necessary to extend the wireless communication range of data packets in the wireless universal serial bus environment.

US Published Application No. 2004-203415 (Wireless Transmission USB hub and Method) discloses a method of extending a transmission distance between a USB host and a USB hub or between USB peripheral apparatuses, by means of a USB logic hub and a USB remote hub wirelessly connected to each other.

However, in this method, the USB logic hub and the USB remote hub are wirelessly connected to each other in order to extend the transmission distance between the USB host and the USB peripheral apparatus which are connected to the USB logic hub and the USB remote hub, respectively, by wire. Such a method does not disclose a method of extending a transmission distance in a wireless USB environment between a wireless USB host and a wireless USB peripheral apparatus.

### SUMMARY OF THE INVENTION

The present invention is made in view of the above-mentioned issues, and it is an aspect of the invention to provide a wireless relay apparatus and method for extending a wireless communication range between a host and a device by relaying packets between the host and the device in a wireless universal serial bus environment.

The aspect of the invention is not limited to the above-mentioned aspect, and other aspects of the invention not described herein will become clear to those skilled in the art upon review of the following description.

According to an aspect of the present invention, a wireless relay apparatus includes: a management packet analyzing unit which receives a management packet including channel time allocation information and information related to the transmission direction of data and analyzes the management packet; a response packet analyzing unit which receives a response packet, which is a response to the management packet, from a wireless USB device and analyzes the response packet; a control unit which controls a stream of data between a wireless USB host and the wireless USB device with reference to the analyzed management packet and the analyzed response packet; and a transmitting/receiving unit which transmits or receives the management packet, the response packet, or data according to the result of the control.

According to another aspect of the invention, a wireless relay method includes: analyzing a management packet which is received from a wireless USB host and includes channel time allocation information and information related to the transmission direction of data; analyzing a response packet which is a response to the management packet and is received from a wireless USB device; controlling a stream of data between a wireless USB host and the wireless USB device with reference to the analyzed management packet and the analyzed response packet; and transmitting or receiving the management packet, the response packet, or data according to the result of the control.

The detailed matters of the other aspects of the invention are included in the detailed description of the invention and the drawings.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a wireless network in an infrastructure mode;

FIG. 2 is a diagram illustrating a wireless network in an ad-hoc mode;

FIG. 3 is a diagram illustrating a data transfer mode of a wire USB;

FIG. 4 is a diagram illustrating a wireless USB system according to an exemplary embodiment of the present invention;

FIG. 5 is a diagram illustrating the principle of an micro-scheduled management command (MMC) for scheduling data communication between a wireless USB host and a wireless relay apparatus according to an exemplary embodiment of the present invention;

FIG. 6 is a diagram illustrating a protocol in which a wireless USB device transmits a device notification time slot (DNTS) message to a wireless relay apparatus according to an exemplary embodiment of the present invention;

FIG. 7 is a diagram illustrating a management packet according to an exemplary embodiment of the present invention;

FIG. 8 is a block diagram illustrating the wireless relay apparatus according to an exemplary embodiment of the present invention; and

FIG. 9 is a flow chart illustrating a wireless relay process according to an exemplary embodiment of the present invention.

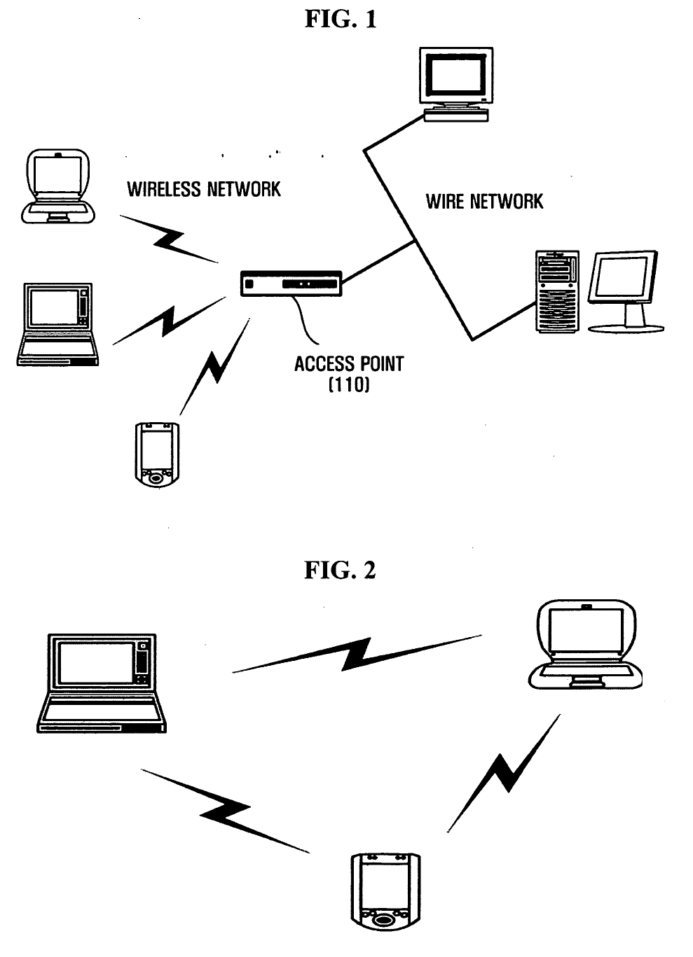

### DETAILED DESCRIPTION OF THE EXEMPLARY EMBODIMENTS OF THE INVENTION

Aspects of the apparatuses and methods of the present invention will be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art. Like reference numerals refer to like elements throughout the specification.

Exemplary embodiments of the present invention will be described below with reference to the accompanying drawings. It will be understood that blocks in the accompanying block diagrams and combinations of operations in the flow charts can be performed by computer program instructions. These computer program instructions can be provided to the processors of, for example, general-purpose computers, special-purpose computers, and programmable data processing apparatuses. Therefore, the instructions performed by a computer or a processor of a programmable data processing apparatus provide a means for executing the functions described within the blocks of the block diagrams or the steps within the flow charts. The computer program instructions can be stored in a computer usable memory or a computer readable memory of the computer or the programmable data processing apparatus in order to realize the functions in a specific manner. Therefore, the instructions stored in the computer usable memory or the computer readable memory can manufacture products including the instruction means for performing the functions described within the blocks of the block diagrams or the steps within the flow charts. Also, the computer program instructions can be loaded into the computer or the computer programmable data processing apparatus. Therefore, a series of operational steps are performed in the computer or the programmable data processing apparatus to generate a process executed by the computer, which makes it possible for the instructions operating the computer or the programmable data processing apparatus to provide steps of executing the functions described within the blocks of the block diagrams or the steps within the flow charts.

Each block or each step may indicate a portion of a code, a module, or a segment having one or more executable instructions for performing a specific logical function (or functions). It should be noted that, in some modifications of the invention, the functions described in the blocks or the steps may be generated in a different order. For example, two blocks or steps continuously shown may actually be performed at the same time, or they may sometimes be performed in reverse order according to the corresponding functions.

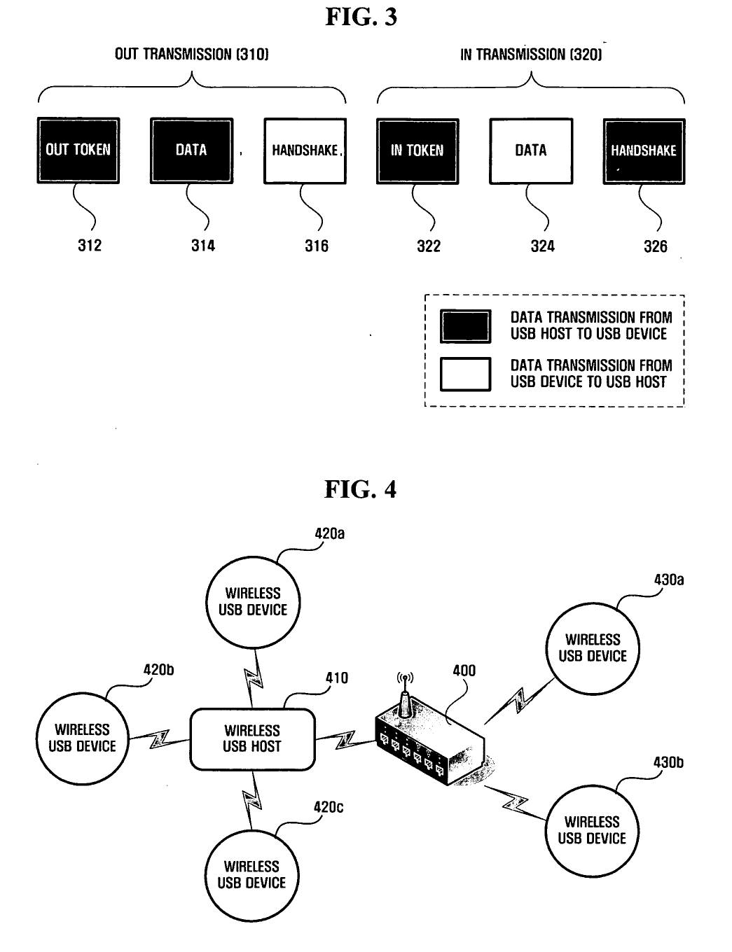

First, a data packet transfer mode of a wireless USB according to an exemplary embodiment of the present invention will be described below in reference to FIGS. 3 to 5, in comparison to a data packet transfer mode of a general wire USB. Hereinafter, the wire USB is referred to as a USB.

FIG. 3 is a diagram illustrating the data transfer mode of the USB.

The data transfer mode of the USB is mainly classified into an OUT transfer mode 310, used for transmitting data packets from a USB host to a USB device, and an IN transfer mode 320, used for transmitting data packets from the USB device to the USB host. During the communication between the USB host and the USB device, the USB host performs polling.

For example, during the OUT transfer mode 310, the USB host transmits an OUT token packet 312 to the USB device, which is a communication target. The OUT token packet 312 includes channel time allocation information and information on a communication direction. The USB device having received the OUT token packet 312 prepares to receive data packets from the USB host, and the USB host transmits a data packet 314 to the USB device. Then, the USB device transmits to the USB host a handshake packet 316 which includes information on the result of the transmission of data.

Meanwhile, during the IN transfer mode 320, the USB host transmits an IN token packet 322 to the USB device, which is a communication target. The IN token packet 322 includes channel time allocation information and information on a communication direction. The USB device having received the IN token packet 322 prepares to transmit data packets, and then transmits a data packet 324 to the USB host. Then, the USB host transmits to the USB device a handshake packet 326 which includes information on the result of the transmission of data.

A delay in data communication results from the communication directions being reversed between, for example, between the data packet 314 and the handshake packet 316, the handshake packet 316 and the IN token packet 322, and the IN token packet 322 and the data packet 324.

FIG. 4 is a diagram illustrating a wireless USB system according to an exemplary embodiment of the present invention.

The wireless USB system includes a wireless USB host 410, one or more wireless USB devices 420a to 420c, 430a and 430b, and a wireless relay apparatus 400. These devices constitute a cluster with the wireless USB host 410 as a main unit. In the wireless USB system, the wireless USB host 410 broadcasts management packets including one or more channel time allocation information items to the USB devices 420a to 420c within the wireless communication range of the wireless USB host 410 to set the channel times of the wireless USB devices 420a to 420c and the communication directions at each channel time. In this way, the communication between the wireless USB host 410 and the wireless USB devices 420a to 420c is performed according to a time division multiple access (hereinafter, referred to as TDMA) scheme.

One or more wireless USB devices 430a and 430b positioned beyond the wireless communication range of the wireless USB host 410 do not receive the management packets from the wireless USB host 410, and thus cannot access the wireless USB network. Therefore, the wireless relay apparatus 400 within the wireless communication range of the wireless USB host 410 communicates with the wireless USB devices 430a and 430b positioned beyond the wireless communication range of the wireless USB host 410 and relays packets between the wireless USB host 410 and the wireless USB devices 430a and 430b.

Thus, the wireless USB devices 430a and 430b should be positioned within the wireless communication range of the wireless relay apparatus 400 in order to receive a wireless relay service. In this case, a plurality of wireless USB devices 430a and 430b may receive the wireless relay service.

Further, one or more physical layers may exist in the wireless relay apparatus 400. When one physical layer exists in the wireless relay apparatus 400, the wireless relay apparatus 400 accesses the network, on the basis of the channel time allocation information specified in the management packets received from the wireless USB host 410 in order to communicate with the wireless USB devices 430a and 430b. When a plurality of physical layers exist in the wireless relay apparatus 400, the wireless relay apparatus 400 is able to communicate with the wireless USB devices 430a and 430b through additional channels corresponding to the physical layers. For example, when a plurality of physical layers exist in the wireless relay apparatus 400, the wireless relay apparatus 400 is able to communicate with the wireless USB host 410 through one physical layer and communicate with the wireless USB devices 430a and 430b through the other physical layers.

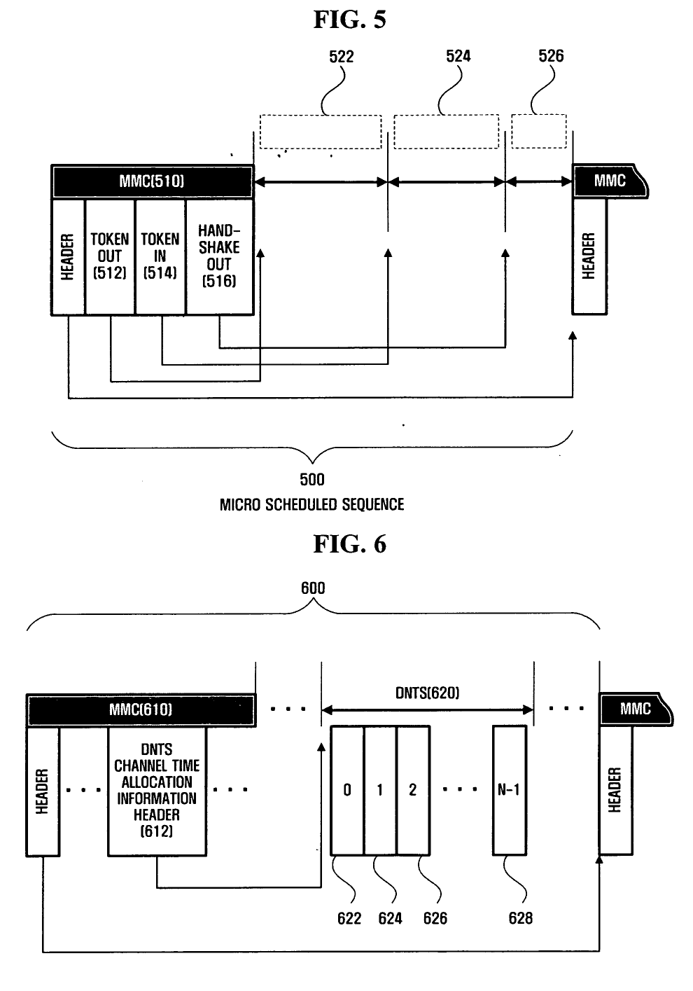

A data transfer mode in the wireless USB system will be described in more detail with reference to FIG. 5.

FIG. 5 is a diagram illustrating the principle of an MMC (micro-scheduled management command) for scheduling data communication between the wireless USB host 410 and the wireless relay apparatus 400 according to an exemplary embodiment of the present invention.

A wireless USB micro-scheduled sequence configuration 500 includes an MMC 510 and a subsequent channel time described in the MMC 510. The wireless USB uses the micro-scheduled sequence configuration 500 to manage the wireless USB transaction protocol. The MMC 510 is used by a host in order to hold and control a wireless USB channel. The MMC 510 is a management packet defined by an application, and mainly comprises specific information elements.

The MMC 510 shown in FIG. 5 includes a channel time slot allocation information element 512 for data-out 522, a channel time slot allocation information element 514 for data-in 524, and a channel time slot allocation information element 516 for handshake-out 526.

The wireless relay apparatus 400 of this exemplary embodiment receives the MMC 510 in order to relay data between the wireless USB host 410 and the wireless USB devices 430a and 430b and broadcasts the MMC 510. Then, the wireless USB devices 430a and 430b positioned beyond the wireless communication range of the wireless USB host 410 are able to receive the MMC 510 broadcasted by the wireless relay apparatus 400 and thus can be allocated with the channel time.

When receiving the MMC 510, the wireless relay apparatus 400 changes an information element identifier of the wireless USB host 410 specified in the MMC 510 into its own unique information element identifier and broadcasts the MMC 510 with the changed information element identifier. This enables the wireless USB devices 420a to 420c within the wireless communication range of the wireless USB host 410 to determine which of the wireless USB host 410 and the wireless relay apparatus 400 the MMC 510 is received from.

FIG. 6 is a diagram illustrating a protocol in which wireless USB devices 430a and 430b sends a DNTS message to the wireless relay apparatus 400 according to an exemplary embodiment of the present invention.

Flow control in the conventional wireless USB communication is used to prevent a buffer underrun or a buffer overrun. In an IN transaction, when wireless USB devices 420a to 420c, 430a and 430b transmits a negative acknowledgement (NAK) handshake to an IN token 514 of the wireless USB host 410, it means that the data to be transmitted from the wireless USB devices 420a to 420c, 430a and 430b to the wireless USB host 410 is not prepared. Further, in an OUT transaction, when wireless USB devices 420a to 420c, 430a and 430b tranmits a NAK handshake to an OUT token 512 of the wireless USB host 410, it means that a buffer of the wireless USB devices 420a to 420c, 430a and 430b for storing data received from the wireless USB host 410 has insufficient capacity. When receiving such a flow control response, the wireless USB host 410 broadcasts the MMC 510 including the IN token 514 or OUT token 512 again in attempt to communicate with the wireless USB devices 420a to 420c, 430a and 430b again.

Since the wireless USB host 410 cannot directly communicate with the wireless USB devices 430a and 430b, the NAK handshake transmitted by the wireless USB device 430a and 430b is transmitted to the wireless relay apparatus 400, and then the wireless relay apparatus 400 transmits the NAK handshake to the wireless USB host 410. At that time, the wireless relay apparatus 400 may transmit the NAK handshake including its own identifier in order to notify that the handshake is not directly transmitted from the wireless USB devices 430a and 430b to the wireless USB host 410, but is instead transmitted to the wireless USB host 410 through the wireless relay apparatus 400.

When the wireless USB host 410 broadcasts the MMC 510 including the IN token 514 or OUT token 512, the wireless relay apparatus 400 changes the information element identifier of the wireless USB host 410 specified in the received MMC 510 into its own information element identifier, and broadcasts the MMC 510 with the changed information element identifier. Thus, each of the wireless USB devices 420a to 420c, 430a and 430b receive the MMC 510 with its respective information element identifier.

At that time, when the buffer of data is ready, the wireless USB devices 430a and 430b transmit a notification ‘Device Endpoint Ready’ to the wireless relay apparatus 400 to notify the wireless relay apparatus 400 that the buffer of data of the wireless USB devices 430a and 430b is ready. Then, the wireless relay apparatus 400 transmits the notification to the wireless USB host 410. In this way, the wireless USB host 410 is able to allocate the channel time for the wireless USB devices 420a to 420c, 430a and 430b having transmitted a preceding notification. The notification is transmitted to a DNTS in a slotted ALOHA mode.

FIG. 6 shows a general structure 600 of a DNTS 620. The DNTS 620 is allocated by the wireless USB host 410, in order to allow individual wireless USB devices 420a to 420c, 430a and 430b to transmit small and asynchronous notification messages to the wireless USB host 410. The wireless USB host 410 places DNTS channel time allocation information 612 in the MMC 610 to directly notify the wireless USB devices 420a to 420c within its own wireless communication range of the DNTS, and to notify the wireless USB devices 430a and 430b beyond its own wireless communication range of the DNTS through the wireless relay apparatus 400. The DNTS is structured into message slots 622 to 628, each having the same logical size.

The DNTS channel time allocation information 612 includes the number of message slots 622 to 628 of the DNTS.

A USB 2.0 has flow control consistent with a lower layer protocol. In the wire USB protocol, when a device sends a flow control response (e.g. NAK), the host polls for a change in state. A USB host controller frequently performs polling for a change in data stream readiness. Such a busy-wait polling method is expensive in that it occupies a large available bandwidth in wireless environments. Therefore, in the wireless USB, a method of occupying a narrower bandwidth is used to resume the data stream after a flow control event.

It is assumed that, after any configuration event, all endpoints for managing the transmission of data are ready in their initial states.

The wireless USB devices 420a to 420c, 430a and 430b can reply to an arbitrary token request with a flow control response. An IN endpoint will return the handshake packet NAK instead of the data packet during the protocol time slot. An OUT endpoint always returns the handshake packet in order to acknowledge the data packet received during the data-step protocol time slot. The OUT handshake packet is a main field and has a handshake code field and an ACK code field indicating the kind of handshakes.

When the wireless USB host 410 receives a flow control response from an endpoint, the wireless USB host 410 removes endpoint's data stream from an active list of endpoints currently being serviced. When the endpoint of the wireless USB devices 420a to 420c, 430a and 430b prepare to resume the data stream (which means that the endpoint has one or more available data having maximum packet sizes and a sufficient storage capacity therefor), the wireless USB devices 420a to 420c, 430a and 430b sends a message to the wireless USB host 410 (with wireless USB devices 430a and 430b going through the wireless relay apparatus 400), indicating that the endpoint is ready, and then the wireless USB host 410 resumes transmitting transaction traffic to the endpoint in the next scheduled service period.

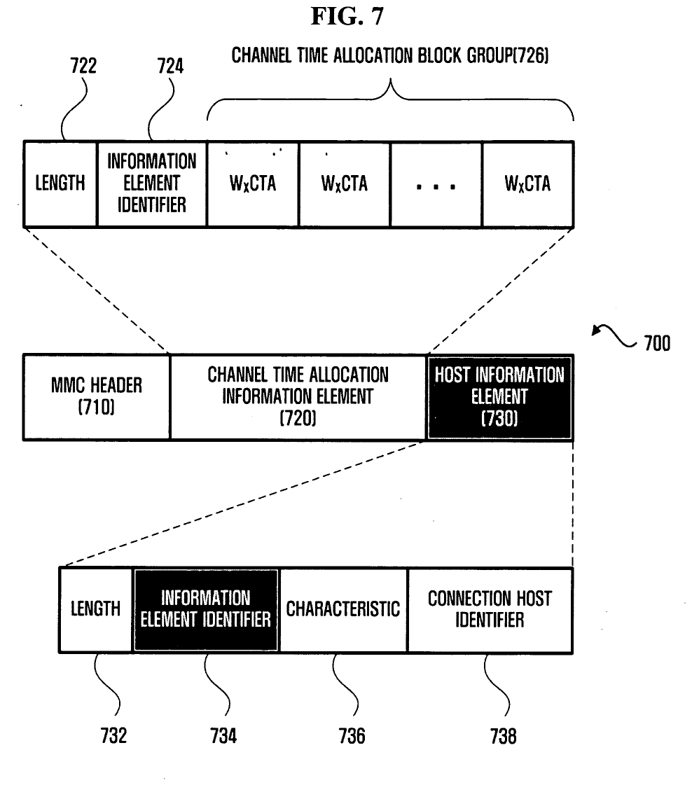

FIG. 7 is a diagram illustrating a management packet according to an exemplary embodiment of the present invention.

FIG. 7 shows an example of a management packet composed of a micro-scheduled management command packet according to wireless USB version 1.0. An MMC packet 700 shown in FIG. 7 can be capsulized in an MAC frame (now shown). The MMC packet 700 may have an MMC header 710, including information on a point in time when the next MMC packet will be transmitted, and MMC information elements 720 and 730, including one or more information elements.

A wireless USB channel time allocation information element (hereinafter, referred to as WCTA IE) field 720 of the MMC information elements 720 and 730 includes channel time allocation information on wireless USB devices 420a to 420c, 430a and 430b. Here, it will be understood that the channel time allocation information corresponds to the channel time slot allocation information element 512 for data-out 522, the channel time slot allocation information element 514 for the data-out 524, and the channel time slot allocation information element 516 for the handshake-out 526, which are described with reference to FIG. 5.

More specifically, the WCTA IE field 720 includes a length field 722, an information element identifier field 724, and a channel time allocation block group 726.

The length field 722 indicates the size of the WCTA IE field 720, and the information element identifier field 724 includes identification information capable of identifying the WCTA IE field 720.

The channel time allocation block group 726 includes one or more channel time allocation (W_{X}CTA) blocks, each including information on channel time when the wireless USB devices 420a to 420c, 430a and 430b can transmit or receive data packets.

Wireless USB version 1.0 includes, for example, three types of channel time allocation blocks, that is, a wireless USB device reception channel time allocation block (W_{DR}CTA block), a wireless USB device transmission channel time allocation block (W_{DT}CTA block), and a wireless USB device notification channel time allocation block (W_{DNTS}CTA block).

A wireless USB host information element (hereinafter, referred to as WHOSTINFO IE) field 730 of the MMC information elements 720 and 730 is a unique name that is used by the wireless USB host 410 to indicate the wireless USB channel.

The WHOSTINFO IE field 730 includes a length field 732, an information element identifier field 734, a characteristic field 736, and a connection host identifier field 738, and is positioned after the WCTA IE field 720 in the MMC packet 700.

The length field 732 indicates the size of the WHOSTINFO IE field 730, and the information element identifier field 734 indicates identification information capable of identifying the WHOSTINFO IE field 730. In this embodiment, the MMC packet 700 created by the wireless USB host 410 uses WHOSTINFO IE as identification information. When the MMC packet 700 including WHOSTINFO IE is broadcasted again by the wireless relay apparatus 400, the wireless USB devices 420a to 420c within the wireless communication range of the wireless USB host 410 may be confused by the MMC packet 700. Therefore, the wireless relay apparatus 400 changes the identification information of the MMC packet 700 into WEXTENDERINFO_IE and broadcasts the MMC packet 700 in order to notify the relay of the MMC packet 700.

The characteristic field 736 includes information on the function supported by the wireless USB host 410, and comprises a connection availability field, a peer to peer dual role device (P2P-DRD) availability field, a MAC layer stream indication field, and a spare field.

The connection availability field is a field that informs wireless USB devices to be connected which type of association the wireless USB host 410 supports, and is classified into a part for restricting the association of the wireless USB device to reconnection, a part for the association of the wireless USB device to connection and reconnection, and a part for supporting connection, reconnection, and new connection.

The P2P-DRD availability field is a field for indicating whether the wireless USB host 410 supports P2P-DRD.

The MAC layer stream indication field is a field used for allowing the wireless USB device to input a value specified in the MAC layer stream indication field into the stream indication field of a MAC layer header for all packets to be transmitted, and includes a transmission rate and a channel number.

As described above, one or more physical layers may exist in the wireless relay apparatus 400. When a plurality of physical layers exist in the wireless relay apparatus 400, the wireless relay apparatus 400 is able to communicate with the wireless USB host 410 through one physical layer, and communicate with the wireless USB devices 430a and 430b through the other physical layers. At that time, when communicating with the wireless USB devices 430a and 430b, the wireless relay apparatus 400 can create and broadcast the MMC packet 700. In this case, the wireless USB devices 430a and 430b, having received the MMC packet 700, are able to communicate with the wireless relay apparatus 400 at the transmission rate, the channel number, and the channel time allocation block specified in the created MMC packet 700.

The connection host identification field 738 is a field containing a unique identifier of the wireless USB host 410. When searching a specific wireless USB host, the wireless USB devices 420a to 420c, 430a and 430b check the connection host identifier field 738.

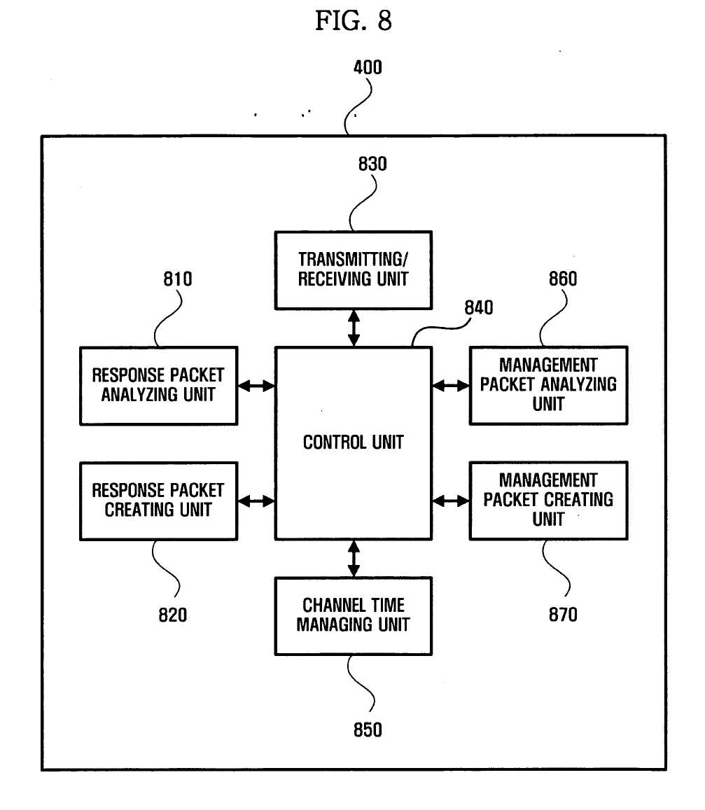

FIG. 8 is a block diagram illustrating the wireless relay apparatus 400 according to an exemplary embodiment of the present invention. The wireless relay apparatus 400 includes a management packet analyzing unit 860, a management packet creating unit 870, a response packet analyzing unit 810, a response packet creating unit 820, a channel time managing unit 850, a transmitting/receiving unit 830, and a control unit 840.

The management packet analyzing unit 860 analyzes a management packet received from the transmitting/receiving unit 830 to extract information on the transmission direction of data required for the wireless USB devices 430a and 430b and channel time allocation information required to perform the transmission of data from the OUT token 512 and the IN token 514 of the packet for the wireless USB devices 430a and 430b.

The management packet includes a micro scheduled management command packet defined by the wireless universal serial bus standard.

The response packet analyzing unit 810 analyzes a response packet transmitted from the transmitting/receiving unit 830 to confirm the states of the wireless USB devices 430a and 430b along the data transmission direction. That is, when data is transmitted from the wireless USB devices 430a and 430b to the wireless USB host 410, the response packet analyzing unit 810 confirms whether data to be transmitted from the wireless USB devices 430a and 430b is ready. When data is transmitted from the wireless USB host 410 to the wireless USB devices 430a and 430b, the response packet analyzing unit 810 confirms whether a storage space for storing data received by the wireless USB devices 430a and 430b is ready.

The management packet creating unit 870 has a function of modifying the management packet received from the wireless USB host 410 to create another management packet. That is, in order to remove the confusion of the wireless USB devices 420a to 420c within the wireless communication range of the wireless USB host 410, the management packet creating unit 870 changes the identification information of the management packet from WHOSTINFO_IE to WEXTENDERINFO_IE.

Further, when a plurality of physical layers exist in the wireless relay apparatus 400, the wireless relay apparatus 400 is able to communicate with the wireless USB devices 430a and 430b through the other physical layers that are not communicating with the wireless USB host 410. In this case, the wireless relay apparatus 400 can create its own unique management packet and broadcast the created management packet, thereby communicating with the wireless USB devices 430a and 430b. Accordingly, the wireless USB devices 430a and 430b within the wireless communication range of the wireless relay apparatus 400 are allocated the channel time, according to the management packet created by the wireless relay apparatus 400, and transmit or receive data.

The response packet creating unit 820 has a function of modifying a response packet received from the wireless USB device 430a or 430b to create another response packet. That is, the response packet creating unit 820 modifies identification information in order to inform the wireless USB host 410 that the response packet is transmitted from the wireless relay apparatus 400.

The information extracted by the management packet analyzing unit 860 and the information extracted by the response packet analyzing unit 810 are transmitted to the control unit 840.

The control unit 840 controls the stream of data transmitted between the wireless USB host 410 and the wireless USB device 430a or 430b, referring to the extracted information, that is, the analyzed management packet and the analyzed response packet. That is, the control unit 840 allows the management packet creating unit 870 and the response packet creating unit 820 to create a response packet and a management packet including the unique identifier of the wireless relay apparatus 400.

The channel time managing unit 850 functions to allocate channel time for performing data communication between the wireless relay apparatus 400 and a plurality of wireless USB devices 430a and 430b by the TDMA system. That is, when a management packet peculiar to the wireless relay apparatus 400 is created and is then transmitted to the wireless USB device 430a or 430b, the channel time managing unit 850 allocates the channel use time of the wireless USB device 430a or 430b. The channel time allocated by the channel time managing unit 850 is transmitted to the management packet creating unit 870, and is then included in the management packet. Then, the management packet is transmitted to the wireless USB device 430a or 430b.

The transmitting/receiving unit 830 transmits or receives the management packet created by the management packet creating unit 870, the response packet created by the response packet generating unit 820, or data transmitted between the wireless USB host 410 and the wireless USB device 430a or 430b.

The physical layer of the wireless USB is based on the ultra wide band physical layer standard of the multi-band OFDM alliance (MBOA). In this case, the physical layer supports a data transmission rate of 53.3, 80, 106.7, 200, 320, 400, or 480 Mb/s and multiple channels. In addition, the physical layer provides proper error detection and correction protocols in order to support a sufficiently wide communication channel.

In the wireless USB device 430a or 430b, it is necessary to transmit or receive data at a transmission rate of 53.3, 106.7, or 200 Mb/s, and it is optional to transmit or receive data at a transmission rate of 80, 160, 320, 400, or 480 Mb/s. The wireless USB host 410 needs to support all transmission rates for the transmission and reception of data. Since in this exemplary embodiment of the present invention the wireless relay apparatus 400 transmits the unique management packet and data and receives the response packet and data from wireless USB devices 430a and 430b, the transmitting/receiving unit 830 of the wireless relay apparatus 400 can also support all transmission rates for the transmission and reception of data.

The control unit 840 controls the management packet analyzing unit 860, the management packet creating unit 870, the response packet analyzing unit 810, the response packet creating unit 820, the channel time managing unit 850, the transmitting/receiving unit 830, and the wireless relay apparatus 400.

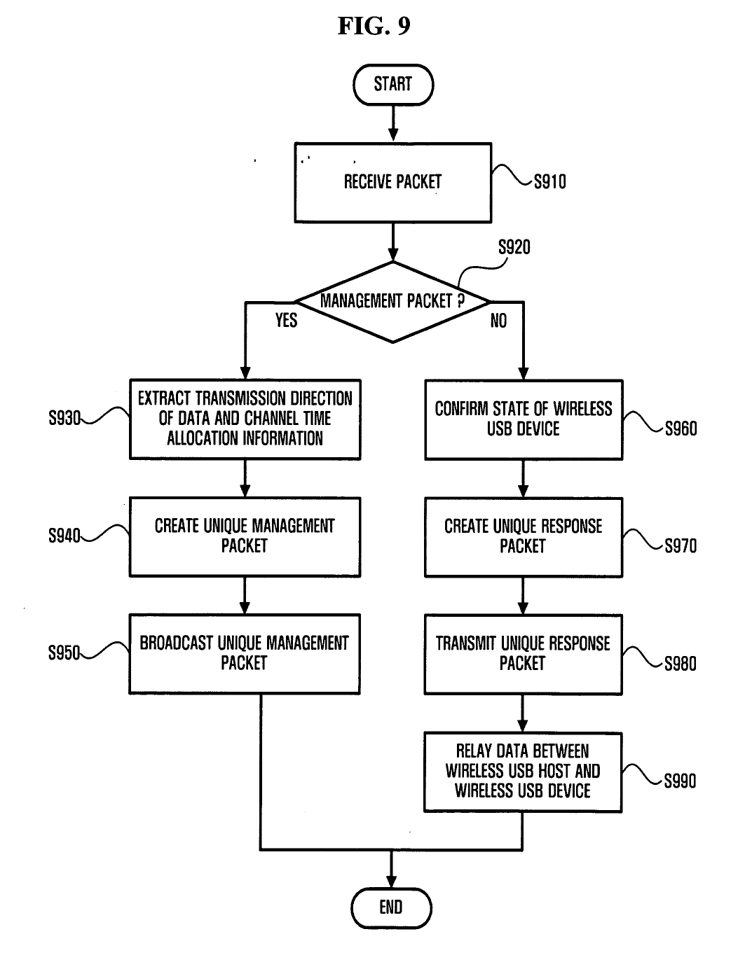

FIG. 9 is a flow chart illustrating a wireless relay process according to an exemplary embodiment of the present invention.

First, the transmitting/receiving unit 830 of the wireless relay apparatus 400 receives a predetermined packet in order to relay the management packet, the response packet, and data between the wireless USB host 410 and the wireless USB device 430a or 430b (S910). In this case, the received packet may be the management packet received from the wireless USB host 410 or the response packet received from the wireless USB device 430a or 430b. Then, the wireless relay apparatus 400 confirms whether the received packet is the management packet or the response packet (S920). Here, the management packet includes a micro scheduled management command packet defined by the wireless universal serial bus standard.

When the received packet is the management packet, the received packet is transmitted to the management packet analyzing unit 860. Then, the management packet analyzing unit 860 analyzes the management packet received from the transmitting/receiving unit 830 to extract information on the transmission direction of data required for the wireless USB devices 430a and 430b and channel time allocation information required to perform the transmission of data from the OUT token 512 and the IN token 514 of the packet for wireless USB devices 430a and 430b (S930).

The extracted information, that is, the analyzed management packet, is transmitted to the control unit 840, and the control unit 840 controls the stream of data with reference to the received management packet. That is, the control unit 840 confirms that the received packet is the management packet and then transmits the received packet to the management packet creating unit 870.

The management packet creating unit 870 having received the management packet from the control unit 840 modifies the received management packet to create a unique management packet (S940), which is executed to remove the confusion of the wireless USB devices 420a to 420c within the wireless communication range of the wireless USB host 410. The management packet creating unit 870 changes the identifier WHOSTINFOR_IE of the wireless USB host 410 included in the management packet into the unique identifier WEXTENDERINFOR_IE of the wireless relay apparatus 400.

At that time, a plurality of physical layers may exist in the wireless relay apparatus 400. In this case, the control unit 840 may allow the management packet creating unit 870 to create a management packet unique to the wireless relay apparatus 400. Then, the wireless USB device 430a or 430b within the wireless communication range of the wireless relay apparatus 400 is allocated the channel time according to the unique management packet of the wireless relay apparatus 400 which is created by the management packet creating unit 870, and transmits or receives data.

When the unique management packet created by the management packet creating unit 870 is broadcasted through the transmitting/receiving unit 830 (S950), the wireless USB device 430a or 430b within the wireless communication range of the wireless relay apparatus 400 receives the unique management packet, creates a response packet according to the channel time specified in the unique management packet, and then transmits the response packet.

The transmitting/receiving unit 830 receives the response packet from the wireless USB device 430a or 430b, and transmits the response packet to the response packet analyzing unit 810.

Then, the response packet analyzing unit 810 analyzes the response packet received from the transmitting/receiving unit 830 and confirms the state of the wireless USB device 430a or 430b in the transmission direction of data (S960). That is, when data is transmitted from the wireless USB device 430a or 430b to the wireless USB host 410, the response packet analyzing unit 810 confirms whether data to be transmitted from the wireless USB device 430a or 430b is prepared. In addition, when data is transmitted from the wireless USB host 410 to the wireless USB device 430a or 430b, the response packet analyzing unit 810 confirms whether a storage space for storing the data transmitted from the wireless USB device 430a or 430b is prepared.

The extracted information, that is, the analyzed response packet is transmitted to the control unit 840, and the control unit 840 controls the stream of data with reference to the received response packet. That is, the control unit 840 confirms that the received packet is the response packet and then transmits the received packet to the response packet creating unit 820.

The response packet creating unit 820 having received the response packet from the control unit 840 modifies the response packet to create a unique response packet (S970). That is, the control unit 840 modifies the received response packet into a response packet including its own unique identifier in order to notify the wireless USB host 410 that the response packet is transmitted from the wireless relay apparatus 400.

The unique response packet created by the response packet creating unit 820 is transmitted to the transmitting/receiving unit 830, and the transmitting/receiving unit 830 transmits the unique response packet to the wireless USB host 410 (S980). Then, the wireless USB host 410 confirms the received response packet and broadcasts the management packet including the channel time allocation information related to the wireless USB device 430a or 430b which is not within the wireless communication range of the wireless USB host 410, but is within the wireless communication range of the wireless relay apparatus 400.

The wireless relay apparatus 400 having received the management packet including the channel time allocation information related to the wireless USB device 430a or 430b changes the received management packet into a management packet including its own unique identifier and broadcasts the management packet. In addition, the wireless relay apparatus 400 receives a response packet from the wireless USB device 430a or 430b, having received the management packet to change the received response packet into a response packet including its own unique response packet, and then transmits the response packet to the wireless USB host 410. In this way, the wireless relay apparatus 400 relays data communication between the wireless USB host 410 and the wireless USB device 430a or 430b (S990).

While the exemplary embodiments of the present invention have been described above with reference to the accompanying drawings, it will be understood by those skilled in the art that various modifications and changes of the exemplary embodiments of the present invention can be made without departing from the scope and spirit of the invention. Therefore, it should be understood that the above-described exemplary embodiments are not restrictive, but illustrative in all aspects.

As described above, according to the wireless relay apparatus and the wireless relay method of the exemplary embodiments of the invention, the following effects may be obtained.

In the transmission and reception of packets between a host and a device in a wireless universal serial bus environment, the packets can be relayed therebetween, which makes it possible to extend the wireless communication range between the host and the device.

What is claimed is:

1. A wireless relay apparatus comprising:
a management packet analyzing unit which receives a management packet including channel time allocation information and information related to the transmission direction of data and analyzes the management packet;
a response packet analyzing unit which receives a response packet, which is responsive to the management packet, from a wireless USB device and analyzes the response packet;
a control unit which controls a stream of data between a wireless USB host and the wireless USB device with reference to the analyzed management packet and the analyzed response packet; and
a transmitting/receiving unit which transmits or receives at least one of the management packet, the response packet, and data according to the control unit.

2. The wireless relay apparatus of claim 1, wherein the management packet includes a micro scheduled management command packet defined by a wireless universal serial bus standard.

3. The wireless relay apparatus of claim 1, further comprising:
a management packet creating unit which changes an identifier of the wireless USB host included in the management packet to create another management packet comprising a unique identifier.

4. The wireless relay apparatus of claim 3, wherein the response packet is created by the wireless USB device in response to the management packet comprising the unique identifier.

5. The wireless relay apparatus of claim 1, wherein the transmitting/receiving unit transmits at least one of the management packet and the response packet with reference to the channel time allocation information.

6. The wireless relay apparatus of claim 1, wherein the transmitting/receiving unit transmits or receives at least one of the management packet, the response packet, and the data through a channel formed by at least one physical layer.

7. A wireless relay method comprising:
analyzing a management packet which is received from a wireless USB host and includes channel time allocation information and information related to the transmission direction of data;
analyzing a response packet which is responsive to the management packet and is received from a wireless USB device;
controlling a stream of data between the wireless USB host and the wireless USB device with reference to the management packet which is analyzed and the response packet which is analyzed; and
transmitting or receiving at least one of the management packet, the response packet, and data according to controlling of the stream of data.

8. The wireless relay method of claim 7, wherein the management packet includes a micro scheduled management command packet defined by a wireless universal serial bus standard.

9. The wireless relay method of claim 7, further comprising changing an identifier of the wireless USB host included in the management packet to create another management packet comprising a unique identifier.

10. The wireless relay method of claim 9, wherein the response packet is created by the wireless USB device in response to the management packet comprising the unique identifier.

11. The wireless relay method of claim 7, wherein the transmitting or receiving of at least one of the management packet, the response packet, and data includes transmitting at least one of the management packet and the response packet with reference to the channel time allocation information.

12. The wireless relay method of claim 7, wherein the transmitting or receiving of at least one of the management packet, the response packet, and data includes transmitting or receiving at least one of the management packet, the response packet, and data through a channel formed by at least one physical layer.
